(19) United States
(12) Patent Application Publication
(10) Pub. No.: US 2002/0099584 A1
(43) Pub. Date: Jul. 25, 2002

(54) System management tool and method

(75) Inventors: Michael Charles Findley, Colorado Springs, CO (US); Walter Richard Lewis, Colorado Springs, CO (US); Janet Lee Hottenstein, Colorado Springs, CO (US); Michele Carmine Ferrante, Colorado Springs, CO (US); Darrell Thomas Hanson, Colorado Springs, CO (US)

Correspondence Address: Law Office of Dale B. Halling, LLC, Suite 311, 24 S. Weber Street, Colorado Springs, CO, 80903, US

(73) Assignee: United States Air Force

(21) Appl. No.: 09/768,993

(22) Filed: Jan. 24, 2001

(51) Int. Cl. G06F 17/60

(52) U.S. Cl. 705/7

(57) ABSTRACT

A system management tool (10) includes an input system (12). An electronic library (14) is connected to the input system (12) and includes a process diagram (16) for modeling a system. An evaluation system (18) is connected to the electronic library (14). A corrective action system (20) is connected to the evaluation system (18). An assessment and analysis system (22) is connected to the corrective action system (20). The assessment and analysis system (22) measures and documents a corrective action.

### FIELD OF THE INVENTION

The present invention relates generally to the field of software tools for organizations and more particularly to a system management tool.

### BACKGROUND OF THE INVENTION

There are a number of software tools for analyzing organizations and businesses. The most widely used and popular is the spreadsheet. Spreadsheets are used for accounting, budgeting, and analyzing numbers including some engineering projects. However, the spreadsheet is a general purpose product that does not integrate all the functions required by many organizational problems. Other products are designed for more specific purposes, such as financial accounting, cost accounting and project accounting problems. While these packages can be very helpful, they all are concerned with the monetary accounting surrounding a problem. Obviously, monetary accounting of organizational problems is very important however, other parameters need to be tracked and monitored to get a complete picture of how an organization system is working. These parameters can include availability of subsystems, failure rates of subsystem, etc. Some of the software packages provide some ability to track other parameters; however, monetary parameters always seem to control the structure.

Thus, there exists a need for a system management tool that is not driven by accounting concerns but by management concerns.

### BRIEF DESCRIPTION OF THE DRAWINGS

FIG. 1 is a block diagram of a system management tool in accordance with one embodiment of the invention;

FIG. 2 is a block diagram of a system management tool in accordance with one embodiment of the invention;

FIG. 3 is a screen shot of a home page of a system management tool in accordance with one embodiment of the invention;

FIG. 4 is a screen shot of a database query in a system management tool in accordance with one embodiment of the invention;

FIG. 5 is a screen shot of a database report in a system management tool in accordance with one embodiment of the invention;

FIG. 6 is a screen shot of a graph of a metric in a system management tool in accordance with one embodiment of the invention;

FIG. 7 is a screen shot of a graph of a metric in a system management tool in accordance with one embodiment of the invention;

FIG. 8 is a screen shot of a graph of a metric in a system management tool in accordance with one embodiment of the invention; and

FIG. 9 is a flow char t of the steps used in a met hod of operating a system management tool in accordance with one embodiment of the invention.

### DETAILED DESCRIPTION OF THE DRAWING

A system management tool includes an input system. An electronic library is connected to the input system and includes a process diagram for modeling a system. An evaluation system is connected to the electronic library. A corrective action system is connected to the evaluation system. An assessment and analysis system is connected to the corrective action system. The assessment and analysis system measures and documents a corrective action. The tool is designed to monitor a system, which is defined in the process diagram. The tool not only includes an evaluation system but a corrective action system. An assessment and analysis system is used to determine how well the corrective action is being implemented.

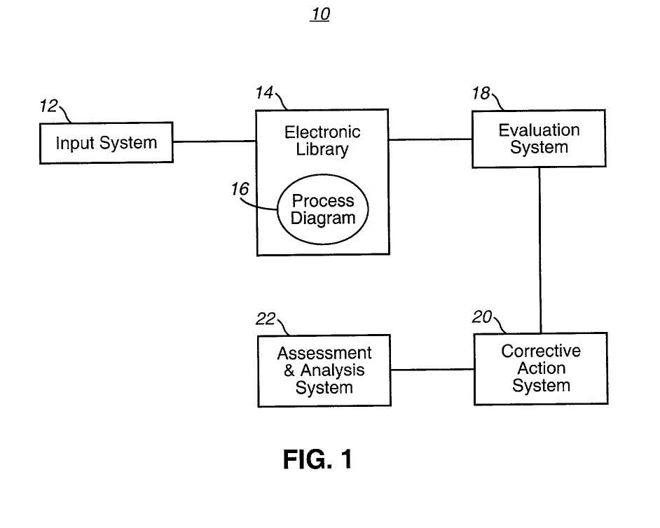

FIG. 1 is a block diagram of a system management tool 10 in accordance with one embodiment of the invention. An input system 12 is connected to an electronic library 14. The electronic library 14 stores all the data. The input system 12 can be a terminal in which the data is manually entered or the data can be automatically received from a subsystem in the system being monitored. The electronic library 14 also includes a process diagram 16. The process diagram describes all the inputs into and outputs from the system. An evaluation system 18 is connected to the electronic library 14. The evaluation system 18 compares the system's performance against a number of different metrics (plurality of metrics). A corrective action system 20 is connected to the evaluation system 18. The corrective action system 20 includes plans to correct concerns discovered by the evaluation system 18. The corrective action system 20 includes metrics to determine if the corrective action worked. An assessment and analysis system 22 is connected to the corrective action system 20. The assessment and analysis system 22 measures any corrective actions. Financial information is treated as just another input or output of the system by the tool 10. As a result, the tool is not limited to or by an accounting system mentality.

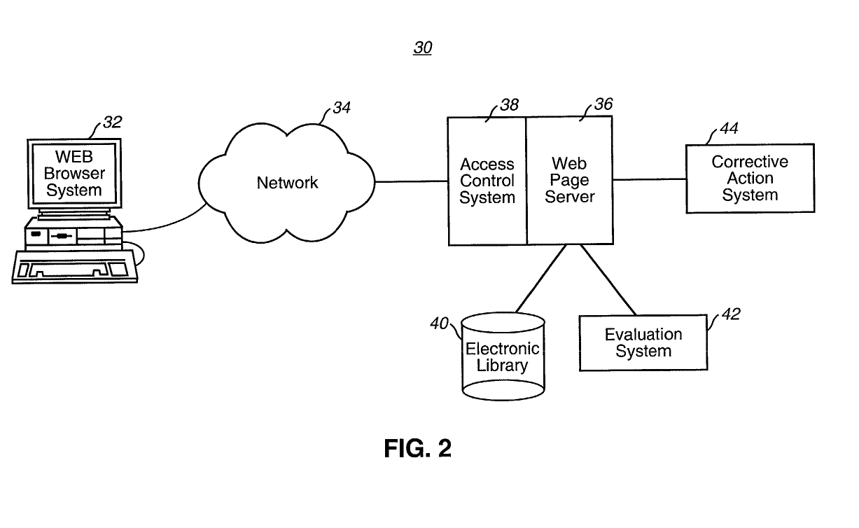

FIG. 2 is a block diagram of a system management tool 30 in accordance with one embodiment of the invention. A user of the tool 30 may access the tool using a network (e.g., Internet—World Wide Web). A user having a computer 32 with a web browser system connects through a network 34 to a web page server 36. An access control system 38 limits access to the web page server 36. In one embodiment, the access control system 38 requires a correct password be entered before the user is allowed access. In other embodiments, further security measures are implemented. The web page server 36 is connected to an electronic library 40. The electronic library 40, in this embodiment, includes both data from the system or systems being monitored and documents that are required by personnel working on the system. An evaluation system 42 is connected to the web page server 36. A corrective action system 44 is connected to the web page server 36. By having the tool 30 designed for a network, it allows the tool to be shared by multiple users in many different locations.

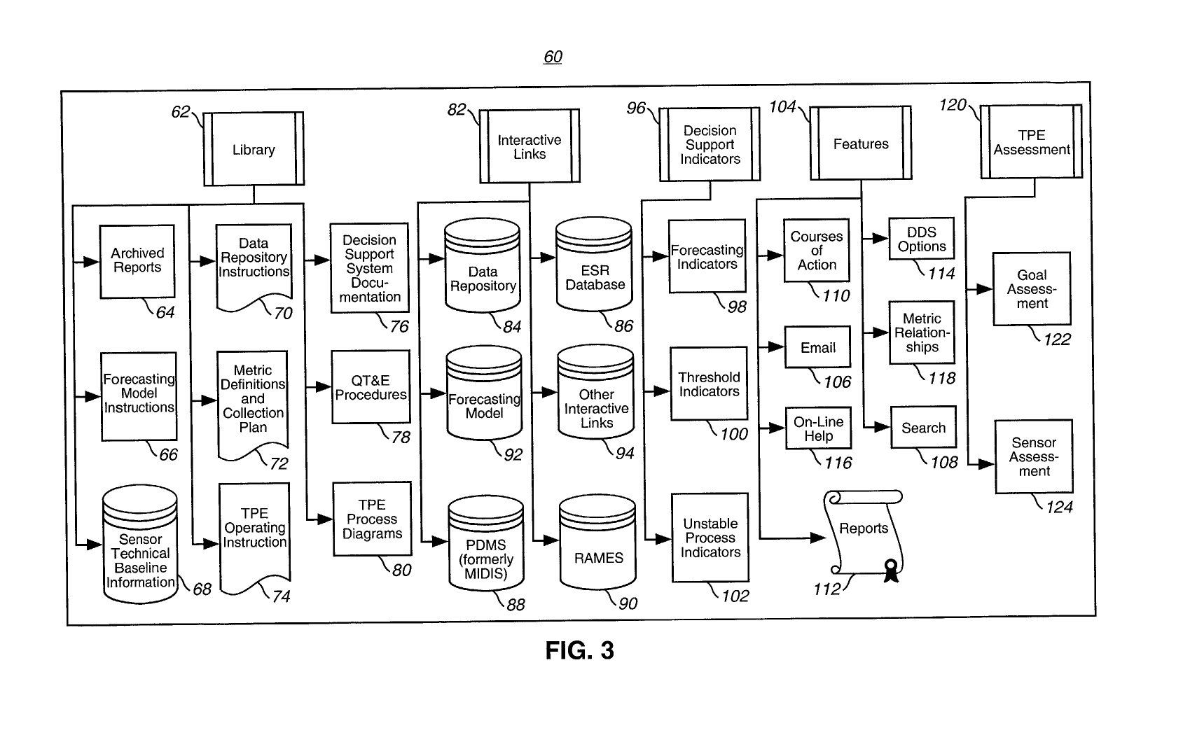

FIG. 3 is a screen shot of a home page 60 of a system management tool in accordance with one embodiment of the invention. The home page 60 is designed to have a graphical look that emphasizes the functions of the tool. The graphical symbols are hyperlinks. An electronic library 62 provides access to a number of useful documents and reports. For instance, this embodiment, has archived reports 64, forecasting model instructions 66, sensor technical baseline information 68, data repository instructions 70, metric definitions and collection plan 72, Technical Performance Evaluation (TPE) operating instruction 74, decision support system documentation 76, Qualification Test and Evaluation (QT&E) Procedures 78 and TPE Process Diagrams 80. This allows the electronic library 62 to contain most of the reference material that may be required by users of the system or systems. Interactive links (plurality of interactive links) 82 are next to the library 62 and includes the data repository (central data repository) 84. Other databases 86 are also accessible. In addition, other tools 88, 90 are accessible. A forecasting model (forecasting tool) 92 is accessible and other links 94 may also be accessible. A decision support indicators section (evaluation system) 96 is next to the interactive links 82. Under the decision support indicators 96 are forecasting indicators 98, threshold indicators 100 and unstable process indicators 102. Next to the decision support indicators 96 is a features section 104. The features section 104 includes a number of different options, such as email 106 and search 108 capabilities. A courses of action section 110 is used to determine and document corrective actions. A report writing feature (report writing system) 112 simplifies the process of collecting data and information for reports, since all the required data and information is part of the system and can be cut and pasted into a report. In addition, the reports section 112 has a report writing wizard that contains the basic format and layout for many required reports. The features section also contains a Decision Support System (DSS) options section 114, on-line help section 116 and metric relationships section 118. A TPE assessment section 120 is next to the features section 104. The TPE assessment section 120 includes a goal assessment system 122 and a sensor assessment section 124.

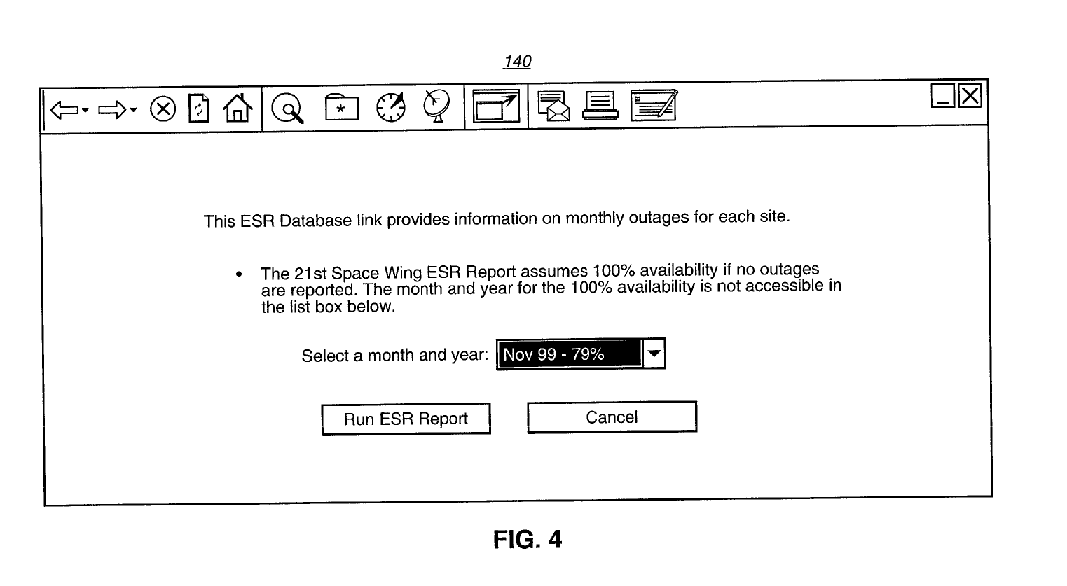

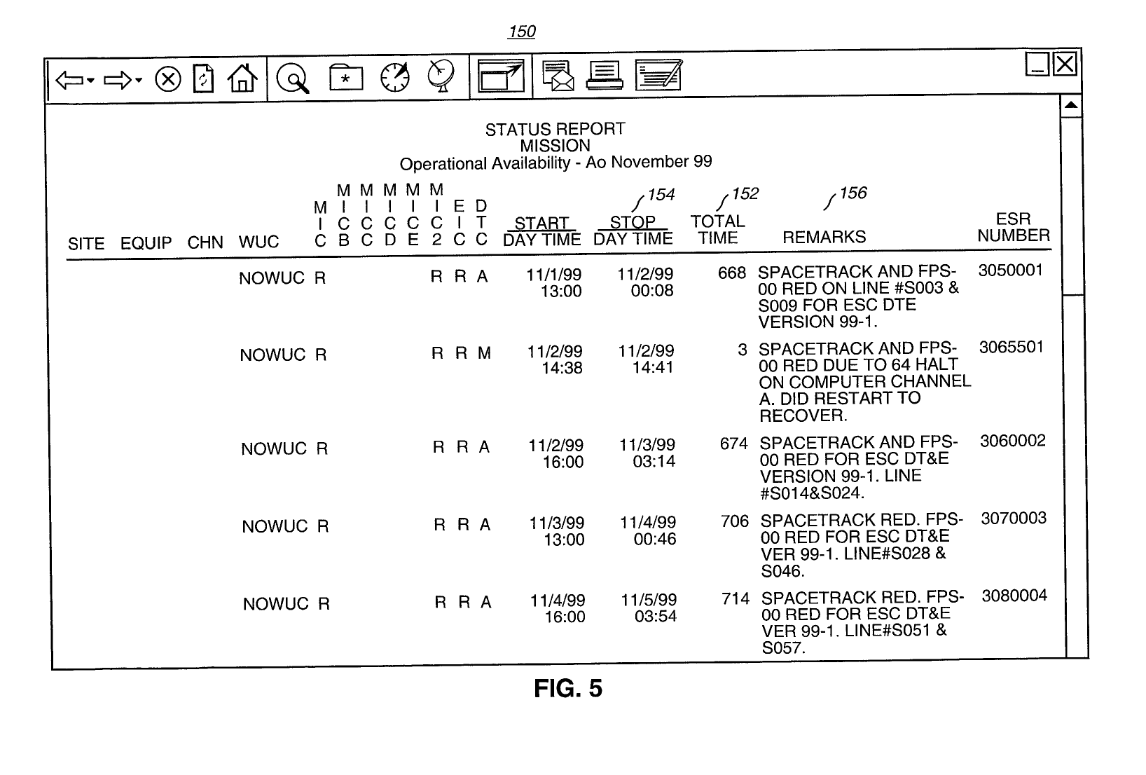

FIG. 4 is a screen shot 140 of a database query in a system management tool in accordance with one embodiment of the invention. The screen shot 140 shows that the user has selected the November 1999 ESR report which has a 79% availability rating. FIG. 5 is a screen shot of a database report 150 in a system management tool in accordance with one embodiment of the invention. The user receives the report shown in FIG. 5. This allows the user to understand why the system received a 79% availability rating for the month. The report 150 shows the total time 152 and date 154 the system was down. The remarks section 156 explains why the system was down. A closer look at the remarks section 156 shows the system was down mainly to test new software versions. A manager might use this information to justify equipment to test the software other than by using the operational system.

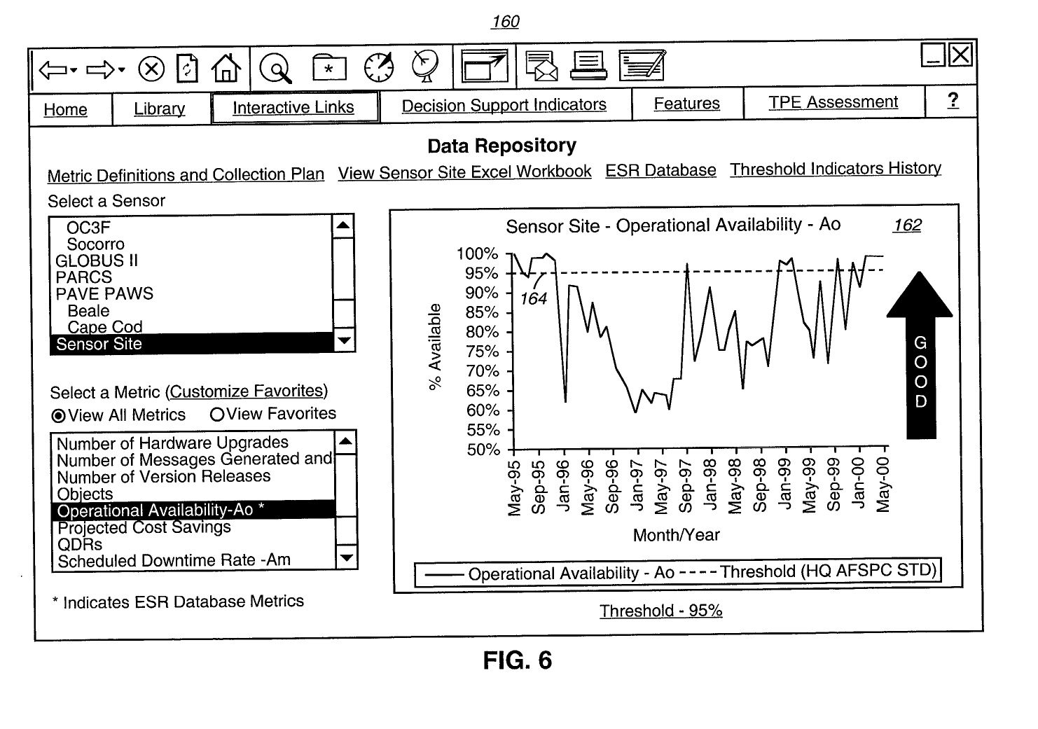

FIG. 6 is a screen shot 160 of a graph of a metric in a system management tool in accordance with one embodiment of the invention. The screen shot 160 shows a graph (graph system) of the operational availability of a sensor site 162. A threshold 164 of 95% is shown on the graph. It is easy to see that the sensor site is rarely making its goal of 95% operational availability.

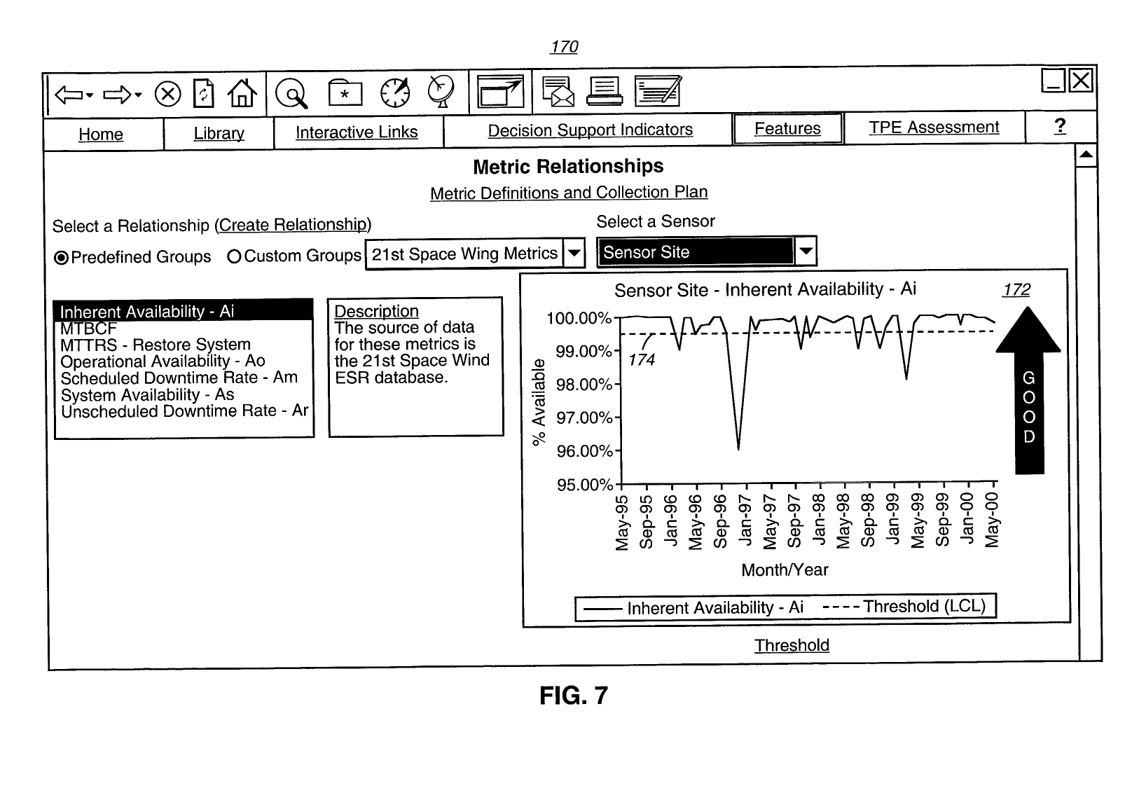

FIG. 7 is a screen shot 170 of a graph of a metric in a system management tool in accordance with one embodiment of the invention. This screen shot 170 shows a graph of an inherent availability of a sensor site 172. The target or threshold 174 for this metric is about 99.5%. This sensor site is generally meeting this metric requirement. If this is the same sensor site as shown in FIG. 6, then it would be important to determine what the difference is between these two metrics. The screen shot lists those metrics related to inherent availability and provides for comparison of related metrics. This screen shot contributes to the electronic library, evaluation system, assessment and analysis system and the corrective action system. The electronic library has a definition for all these metrics.

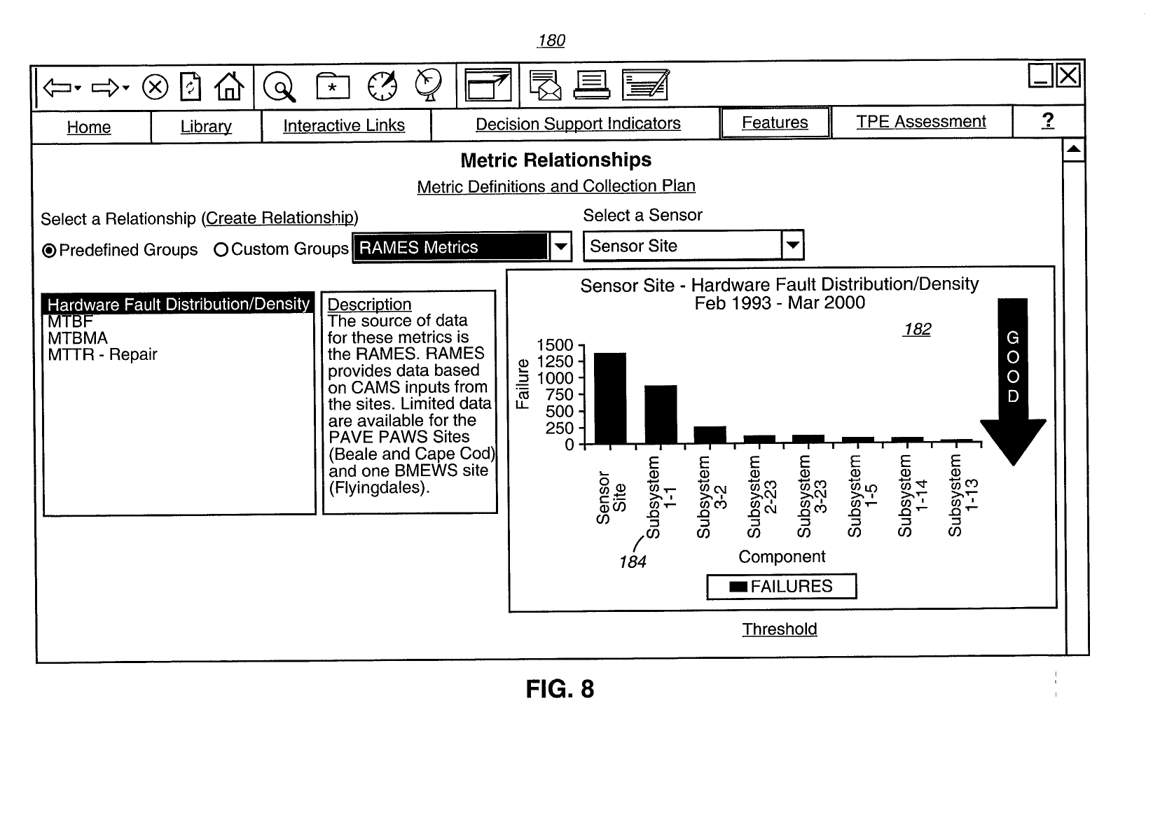

FIG. 8 is a screen shot 180 of a graph of a metric in a system management tool in accordance with one embodiment of the invention. The screen shot 180 shows a bar chart of fault distribution density 182 between February 1993 and March 2000. It is easy to see that subsystem 1-1 184 is the major source of faults. This screen shot lists those metrics related to hardware fault distribution density and provides for comparison of related metrics. This screen shot contributes to the electronic library, evaluation system, assessment and analysis system and the corrective action system.

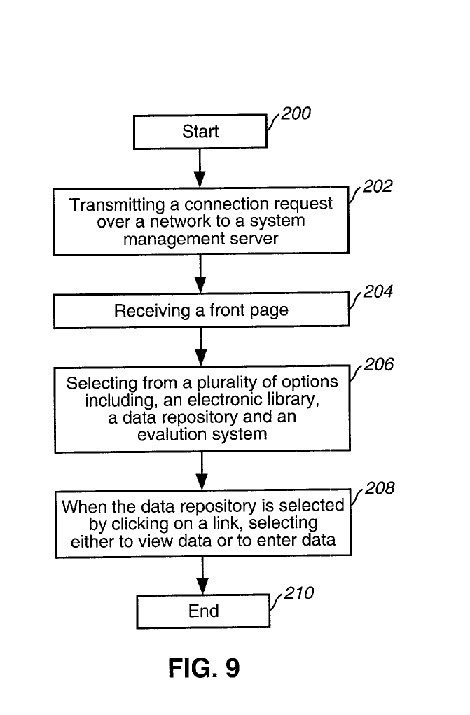

FIG. 9 is a flow chart of the steps used in a method of operating a system management tool in accordance with one embodiment of the invention. The process starts, step 200, by transmitting a connection request over a network to a project management server at step 202. A front page is received at step 204. The user then selects from a plurality of options that include an electronic library, a data repository or an evaluation system at step 206. When the data repository is selected by clicking on a link at step 208, the user selects either to view data or enter data which ends the process at step 210. In one embodiment, the electronic library is selected and the user then selects from a process diagram, an instruction manual or a dictionary. When the evaluation system is selected the user can select a metric to analyze. A graph of the metric may be displayed. In one embodiment, the graph includes a threshold. When the evaluation system is selected, the user can choose between a set of metrics that exceed their threshold (plurality of associated thresholds). The user can also choose to view a set of metrics that are unstable. An unstable metric is a metric which may have process problems.

Thus, there has been described a system management tool that is not a slave to accounting systems but does address management concerns. The tool is designed to be used over a network, which allows widely dispersed users to access the tool. This makes the tool useful to both workers, mid-level managers and high-level managers and avoids repeating information throughout an organization.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system management tool, comprising:
an input system;
an electronic library connected to the input system and including a process diagram for modeling a system;
an evaluation system connected to the electronic library;
a corrective action system connected to the evaluation system; and
an assessment and analysis system connected to the corrective action system, the assessment and analysis system measuring a corrective action.

2. The tool of claim 1, further including a report writing wizard with cut and paste functions from the electronic library, the evaluation system, the corrective action system and the assessment and analysis system.

3. The tool of claim 1, further including a plurality of interactive links connected to the evaluation system.

4. The tool of claim 3, wherein the interactive links include a central data repository storing all the data for the system.

5. The tool of claim 1, further including a plurality of hyperlinks that provide access to the electronic library, the evaluation system and the corrective action system.

6. The tool of claim 1, wherein the evaluation system includes a plurality of metrics and a plurality of associated thresholds.

7. The tool of claim 6, wherein the evaluation system includes a graphing system for displaying each of the plurality of metrics and each of the plurality of associated thresholds.

8. The tool of claim 1, wherein the corrective action system includes a forecasting tool.

9. A system management tool, comprising:
a web browser system;
a network connected to the web browser system;
an access control system connected to the network;
a web page server connected to the access system;
an electronic library accessible from the web page server;
an evaluation system accessible from the web page server; and
a corrective action system accessible from the web page server.

10. The tool of claim 9, further including an assessment and analysis system accessible from the web page server, the assessments and analysis system measuring a corrective action.

11. The tool of claim 9, wherein the electronic library includes a process diagram, defining an input and an output.

12. The tool of claim 9, further including a report writing system accessible by the web browser system.

13. The tool of claim 9, further including an interactive link accessible from the web page server containing a data repository.

14. A method of operating a system management tool, comprising the steps of:
a) transmitting a connection request over a network to a system management server;
b) receiving a front page;
c) selecting from a plurality of options including, an electronic library, a data repository and an evaluation system; and
d) when the data repository is selected by clicking on a link, selecting either to view data or to enter data.

15. The method of claim 14, further including the step of:
e) when the electronic library is selected, selecting from a process diagram, an instruction manual or a dictionary.

16. The method of claim 14, further including the steps of:
e) when the evaluation system is selected, selecting a metric to analyze;
f) displaying a graph of the metric.

17. The method of claim 16, further including the step of:
g) displaying a threshold.

18. The method of claim 14, further including the step of:
e) when the evaluation system is selected, selecting a set of metrics that exceed their threshold.

19. The method of claim 14, further including the step of:
e) when the evaluation system is selected, selecting a set of metrics that are unstable;
f) when the evaluation system is selected, selecting a set of forecasting indicators.

20. The method of claim 19, wherein an unstable metric is a metric which may have process problems.
